(19) United States
(12) Patent Application Publication
(10) Pub. No.: US 2026/0347550 A1
(43) Pub. Date: Nov. 5, 2026

(54) Synthesizing Isobutylene-Co-Paramethylstyrene Based Elastomers with Broad Molecular Weight Distributions

(71) Applicant: ExxonMobil Chemical Patents Inc., Spring, TX (US)

(72) Inventor: Sunny Jacob, Seabrook, TX (US)

(21) Appl. No.: 19/110,242

(22) PCT Filed: Sep. 1, 2023
(86) PCT No.: PCT/US2023/073301

§ 371 Date: Mar. 10, 2025

Related U.S. Application Data
(60) Provisional application No. 63/405,927, filed on Sep. 13, 2022.

(51) Int. Cl. C08J 3/00; C08F 8/20; C08F 8/50; C08F 210/10; C08K 5/14

(52) U.S. Cl. CPC C08J 3/005; C08F 8/20; C08F 8/50; C08F 210/10; C08K 5/14; C08J 2323/22; C08J 2323/28

(57) ABSTRACT

Methods for preparing isobutylene-co-paramethylstyrene compositions are described herein. For example, one or more methods include treating an isobutylene-co-paramethylstyrene based elastomer with a peroxide initiator at a temperature greater than or equal to 160 °C to chemically induce a thermal breaking along the copolymer backbone of the isobutylene-co-paramethylstyrene based elastomer. The peroxide treatment can produce a modified isobutylene-co-paramethylstyrene based elastomer having a Mw/Mn ratio greater than 2.5.

### CROSS-REFERENCE TO RELATED APPLICATION

This application claims priority to and the benefit of U.S. Provisional Patent Application 63/405,927, filed 13 Sep. 2022, entitled SYNTHESIZING ISOBUTYLENE-CO-PARAMETHYLSTYRENE BASED ELASTOMERS WITH BROAD MOLECULAR WEIGHT DISTRIBUTIONS, the disclosure of which is incorporated herein by reference in its entirety.

### FIELD OF INVENTION

This application relates to methods for controlling the molecular weight distribution of isobutylene-co-paramethylstyrene based elastomers and, in particular, utilizing a peroxide treatment to initiate chemical and thermal cracking of isobutylene-co-paramethylstyrene based elastomers to increase the fraction of low molecular weight species.

### BACKGROUND

Molecular weight distribution (MWD=Mw/Mn), also called polydispersity index, has a significant effect on the mechanical and physical bulk properties of polymers and resultant compounded products. For example, adjusting the balance of the MWD of isobutylene-co-paramethylstyrene elastomers (e.g., controlling high versus low molecular weight fractions) can affect various mechanical properties and/or processability factors of the polymer product. High molecular weight fractions contribute to mechanical properties such as: tensile break, elongation, impact strength, and the like. Low molecular weight fractions contribute to processability factors such as: low melt viscosity, plasticizer quality, and the like. Accordingly, the breadth of MWD can affect the suitability of isobutylene-co-paramethylstyrene elastomers for various applications, such as tire products (e.g., innerliners and/or bladder components) or pharmaceutical products (e.g., pharmaceutical closures).

### SUMMARY

In various non-limiting embodiments described herein, a method for preparing an isobutylene-co-paramethylstyrene composition is provided. The method can comprise treating an isobutylene-co-paramethylstyrene based elastomer with a peroxide initiator at a temperature greater than or equal to about 160 °C to chemically induce a thermal breaking along the copolymer backbone of the isobutylene-co-paramethylstyrene based elastomer. The treating can produce a modified isobutylene-co-paramethylstyrene based elastomer having a Mw/Mn ratio greater than 2.5.

In one or more non-limiting embodiments described herein, another method for preparing an isobutylene-co-paramethylstyrene composition is provided. The method can comprise increasing a low molecular weight fraction of an isobutylene-co-paramethylstyrene based elastomer by mixing the isobutylene-co-paramethylstyrene based elastomer with a peroxide initiator at a temperature greater than or equal to about 160 °C. The mixing produces a modified isobutylene-co-paramethylstyrene based elastomer having a Mw/Mn ratio greater than 2.5.

In one or more non-limiting embodiments described herein, an isobutylene-co-paramethylstyrene based elastomer is provided. The isobutylene-co-paramethylstyrene based elastomer can comprise 80 to 99.5 mole percent of isobutylene, 0.5 to 20 mole percent of paramethylstyrene, and have a substantially homogenous compositional distribution with a Mw/Mn ratio greater than 6.0.

In some embodiments, the isobutylene-co-paramethylstyrene based elastomer can be comprised within a cured article that is a tire innerliner, an innertube, a wire coating, a pharmaceutical rubber stopper, a hose, a film, an adhesive, or a sealant.

These and other features and attributes of the disclosed methods for controlling the MWD of isobutylene-co-paramethylstyrene based elastomers of the present disclosure and their advantageous applications and/or uses will be apparent from the detailed description which follows.

### DETAILED DESCRIPTION

This application relates to methods for controlling the MWD of isobutylene-co-paramethylstyrene based elastomers compositions and, in particular, broadening the MWD of isobutylene-co-paramethylstyrene based elastomer compositions to a range of, for example, about 2.5 to 10 for various applications such as tire or pharmaceutical products.

For example, with regards to tire applications (e.g., tire innerliners), the compound Mooney viscosity and the compound Mooney relaxation are important for producing tires with good innerliner splicing characteristics and splice strength after tire curing. A certain ratio of the high and low molecular weight fractions is needed to obtain a balance of mechanical strength and ease of processing with good splice integrity. For instance, certain fraction of higher molecular weight is necessary for desired mechanical properties, while a certain fraction of low-molecular weight portion helps improve the processability as the low molecular weight fraction can act as a plasticizer. Thus, it is important to have a controlled, broad MWD for commercial polymers so that the tire producers/converters/fabricators can process the products with faster cycle time, good surface appearance, splice integrity, strength, etc. in the final product. A lower dispersity (narrower MWD) leads to difficulty in processing and potentially a weak splice strength due slow relaxation of the compounds. A high Mooney viscosity can also be contributed to a narrow MWD, which can negatively affect processability of isobutylene-co-paramethylstyrene based elastomers.

The present disclosure provides methods for producing isobutylene-co-paramethylstyrene based elastomer compositions having a broad MWD. The elastomer compositions described herein are particularly useful in applications where isobutylene-co-paramethylstyrene elastomers or brominated isobutylene-co-paramethylstyrene elastomers are used and there is a desire to obtain high green strength while increasing the rate of stress relaxation.

For example, various embodiments described herein provide one or more methodologies for broadening the MWD of isobutylene-co-paramethylstyrene elastomer compositions (e.g., isobutylene-co-paramethylstyrene elastomers and/or brominated isobutylene-co-paramethylstyrene elastomers) by varying the concentration of low molecular weight fractions via a chemically induced thermal breaking of the copolymer backbone with a peroxide initiator. In various embodiments, the isobutylene-co-paramethylstyrene based elastomer compositions can be subjected to the molecular weight modification pre or post bromination. Additionally, the MWD can be further controlled by blending the modified polymers with unmodified polymers having a higher molecular weight and/or narrower MWD. For example, the modified and unmodified elastomers can be blended together at various ratios to achieve a desired MWD. Thus, in accordance with one or more embodiments described herein, the MWD of isobutylene-co-paramethylstyrene based elastomers can be modified by increasing the fraction of low molecular weight species (e.g., having a molecular weight that is less than 100,000 Daltons (Da)) via peroxide treatments performed at elevated temperatures (e.g., about 160 to 190 °C) to induce chemical and/or thermal cracking of the copolymer backbone.

### DEFINITIONS

As used herein, the term “catalyst system,” and grammatical variants thereof, refers to and includes any Lewis acid(s) or other metal complex(es) used to catalyze the polymerization of hydrocarbon monomers and an optional at least one initiator. Other additives may be included, such as catalyst modifiers, for example. The catalyst system is combined with a diluent for polymerization, collectively termed a “polymerization medium.” A “polymerization system,” as used herein, and grammatical variants thereof, refers to the use of a polymerization medium to produce polymers.

As used herein, the term “diluent,” and grammatical variants thereof, refers to a dilution or dissolving agent, including mixtures thereof (e.g., two or more individual diluents). The diluent can further be used to impact reactor mixing (using an overhead blender) as it serves as a dilution agent.

As used herein, the term “solvent,” and grammatical variants thereof, refers to a chemical agent that can dissolve resultant polymers.

A “reactor,” and grammatical variants thereof, as used herein, refers to any container(s) in which a chemical reaction occurs, such as polymerization. Examples of a polymerization reactor include a continuous flow-stirred tank reactor, which utilizes continuous tank agitation, as well as a draft tube type reactor. Various cooling jackets, tubing, and the like, may be used in combination (and may be integral) with the reactor to control or otherwise maintain the reactor temperature during polymerization. Commercial reactors typically can be well mixed vessels of greater than 400 to 500 liters in volume with a high circulation rate provided by a pump impeller. The polymerization and a pump can both generate heat and, in order to keep the slurry cold, the reaction system can include heat exchangers. In some reactors, slurry can circulate through tubes of a heat exchanger. Cooling can be provided, for example, by boiling ethylene on a shell side. Slurry temperature can be set by the boiling ethylene temperature, the required heat flux and the overall resistance to heat transfer.

As used herein, the term “slurry,” and grammatical variants thereof, refers to an amount of diluent comprising polymer that has precipitated from a catalyst system and diluent. The slurry concentration is the weight percent of the partially or completely precipitated polymers based on the total slurry.

As used herein, the term “quench,” and grammatical variants thereof, refers to a process of rapidly heating and mixing a reactor effluent stream with a quench medium, wherein further polymerization is terminated.

The term “polymer,” and grammatical variants thereof, as used herein refers to homopolymers, copolymers, interpolymers, terpolymers, etc. The term “copolymer,” and grammatical variants thereof, is meant to include polymers having two or more monomers. The term “interpolymer,” and grammatical variants thereof, means any polymer or oligomer having a number average molecular weight of 500 or more prepared by the polymerization or oligomerization of at least two different monomers. As used herein, when a polymer is referred to as “comprising” a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, the term “olefin,” and grammatical variants thereof, refers to a hydrocarbon containing a carbon-carbon double bond. An “isoolefin,” and grammatical variants thereof, refers to any olefin monomer having two substitutions on the same carbon. The term “diolefin,” and grammatical variants thereof, refers to any olefin monomer having two double bonds.

“Elastomer” or “elastomeric composition,” as used herein, and grammatical variants thereof, refers to any polymer or composition of polymers consistent with the ASTM D1566-21A (November 2021) definition. Elastomer may be used herein interchangeably with the term “rubber(s).”

“Mooney viscosity,” as used herein, and grammatical variants thereof, is the Mooney viscosity of a polymer or polymer composition. The polymer composition analyzed for determining Mooney viscosity should be substantially devoid of diluent and solvent. For instance, the sample may be placed on a boiling-water steam table in a hood to evaporate a large fraction of the diluent and unreacted monomers, and then, dried in a vacuum oven overnight (12 hours, 90 °C) prior to testing, in accordance with laboratory analysis techniques, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-19A (November 2019, but with the following modifications/clarifications of that procedure. First, sample polymer is pressed between two hot plates of a compression press prior to testing. The plate temperature is 125 °C+/−10 °C instead of the 50+/−5 °C as recommended in ASTM D1646-17, because 50 °C is unable to cause sufficient massing. Further, although ASTM D1646-17 allows for several options for die protection, should any two options provide conflicting results, PET 36 micron is used as the die protection. Further, ASTM D1646-17 does not indicate a sample weight in Section 8; thus, to the extent results may vary based upon sample weight, Mooney viscosity determined using a sample weight of 21.5+/−2.7 grams (g) per D1646-17 Section 8 procedures will govern. Finally, the rest procedures before testing set forth in D1646-17 Section 8 are 23+/−3 °C for 30 minutes in air; Mooney values as reported herein were determined after resting at 24+/−3 °C for 30 minutes in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4@125 °C or ML, 1+8@125 °C), where MU is the Mooney viscosity number, L denotes large rotor (defined as ML in ASTM D1646-17), 1 is the pre-heat time in minutes, 4 or 8 is the sample run time in minutes after the motor starts, and 125 °C is the test temperature. Thus, a Mooney viscosity of 90 determined by the aforementioned method would be reported as a Mooney viscosity of 90 MU (ML, 1+8@125 °C) or 90 MU (ML, 1+4@125 °C). Alternatively, the Mooney viscosity may be reported as 90 MU; in such instance, it should be assumed that the just-described (ML, 1+4@125 °C) method is used to determine such viscosity, unless otherwise noted. In some instances, a lower test temperature may be used (e.g., 100 °C), in which case Mooney is reported as Mooney Viscosity (ML, 1+8@100 °C), or @T°C where T is the test temperature.

The term “blended”, or grammatical variants thereof, refers to a mixture of two or more polymers. Blends can be produced by, for example: solution blending, melt mixing, shear mixing, a combination thereof, and/or the like.

Numerical ranges used herein include the numbers recited in the range. For example, the numerical range “from 1 wt % to 10 wt %” includes 1 wt % and 10 wt % within the recited range.

### Polymerization of Isobutylene-Co-Paramethylstyrene Based Elastomers

As used herein, the term “isobutylene-co-paramethylstyrene based elastomer” can refer to a polyolefin copolymer composition comprising the reaction product of isobutylene and paramethylstyrene. The copolymer can have a substantially homogenous compositional distribution. In various embodiments, the isobutylene-co-paramethylstyrene based elastomers described herein can have an average molecular weight (Mw) ranging from, for example, about 200,000 Da to about 2,000,000 Da (e.g., about 200,000 Da to about 500,000 Da; about 500,000 Da to about 1,000,000 Da; about 1,000,000 Da to about 1,500,000 Da; or about 1,500,000 Da to about 200,000 Da), and a MWD (Mw/Mn) ranging from, for example, less than about 2.5. In one or more embodiments, the isobutylene-co-paramethylstyrene based elastomer can comprise between about 80 and about 99.5 mole percent of the isobutylene and about 0.5 to about 20 mole percent of the paramethylstryene. In various embodiments, the isobutylene-co-paramethylstyrene based elastomers can be substantially linear. Additionally, the paramethylstyrene can be halogenated. For instance, the paramethylstyrene can be characterized by Formula 1.

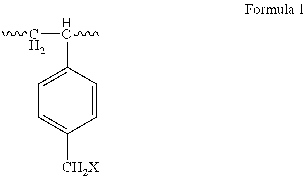

Where “X” is hydrogen, a halogen (e.g., bromine or chlorine), or a combination of a halogen and another functional group such which can be incorporated by nucleophilic substitution of benzylic halogen with othe groups such as: carboxylic acids; carboxy salts, carboxy esters, amides, and imides; hydroxyl, alkoxide; phenoxide; thiolate; thioether; xanthate; cyanide; nitrile; amino, and mixtures thereof. The “ [symbol] ” indicate covalent bonds to isobutylene blocks of the copolymer backbone.

The isobutylene-co-paramethylstyrene based elastomers can be synthesized via a low temperature cationic polymerization processing using a Lewis acid catalyst system (e.g., employing ethylaluminum dichloride or ethylaluminum sequichloride). In one or more embodiments, methyl chloride can be utilized as a diluent for the reaction mixture at a temperature less than, for example, 90 °C; where the methyl chloride acts a solvent for the monomers catalyst, while also acting as a non-solvent for the polymer product, thereby resulting in a slurry. Other suitable diluents include, but are not limited to: methylene chloride, vinyl chloride, and/or ethyl chloride. Further, one or more stabilizing agents (e.g., gel free polymers and/or gelled polymers) can be employed with the slurry polymerization process to stabilize against agglomeration of the slurry polymerization product.

In one or more embodiments, the diluent can serve as a solvent for both the monomer catalyst and the polymer product. For example, the diluent solution can comprise aliphatic hydrocarbons (e.g., hexane, pentane, heptane, and/or the like) and/or mixtures of aliphatic hydrocarbons with slurry-type diluents (e.g., methyl chloride and/or methylene chloride). Additionally, the diluent solution can be utilized along with a catalyst system such as hydrochloric acid and ethylaluminum dichloride or ethylaluminum sequichloride. One of ordinary skill in the art will recognize various advantages for utilizing the respective polymerization methods. For instance, the slurry polymerization process can achieve greater polymer concentration than the solution polymerization.

In various embodiments, the slurry polymerization process can incorporate one or more slurry stabilizers (e.g., butyl dispersions) produced during polymerization in a diluent such as methyl chloride to prevent mass agglomeration of slurry particles. Thereby, slurry stabilizers can enable the formation of dispersed butyl particles containing gel in the reactor without depositing fouling rubber containing gel on the heat transfer surfaces. Through the use of slurry stabilizers it is possible to produce a modified rubber containing as much branching and/or gel as is desired in a practical manner without interfering with the ability to wash the reactor in order to prepare it for reuse.

When employing the slurry polymerization process to copolymerize, for example, isobutylene and paramethylstyrene; no olefinic unsaturation is introduced into the polymer backbone. Therefore, gel production can be avoided, and/or inhibited, even at very high paramethylstyrene incorporation levels. For instance, the crosslinkable active functionality is not introduced thereinto until the copolymer is functionalized (e.g., halogenated in a post polymerization step) and gel formation can be minimized. Thus, slurry polymerization can enable high polymer concentration to be handled at low viscosity with good heat transfer. However, employing solution polymerization can enable homogeneous polymerization and the ability to run subsequent reaction directly on the resulting polymer solution. Additionally, solution polymerization can produce the isobutylene-co-paramethylstyrene based elastomers in a desirable solution state to permit post polymerization chemical modification (e.g., MWD modification via a peroxide treatment).

In one or more embodiments, isobutylene-co-paramethylstyrene based elastomers can be further subjected to a post-polymerization halogenation reaction (e.g., radical bromination) to achieve paramethylstyrene blocks characterized by Formula 1. Prior to halogenation, the copolymerization reaction can be quenched and residual monomers can be removed. The halogenation reactions described herein can be carried out on the copolymer either in solution or in a finely dispersed slurry. Suitable solvents for carrying out the halogenation reaction in solution include low boiling hydrocarbons (e.g., C₄ to C₇) and halogenated hydrocarbons. The halogenation reaction can also be conducted with the copolymer as a fine slurry in a suitable diluent, which is a poor solvent for the copolymer.

In one or more embodiments, the isobutylene-co-paramethylstyrene copolymers can contain little to no backbone olefinic unsaturation contribution from the paramethylstyrene, and the primary reactive halogenation site is the enchained paramethylstyrene moiety. For example, radical halogenation (e.g., radical bromination) of the enchained paramethylstyrene moiety in the isobutylene-co-paramethylstyrene copolymer can be made highly specific with substitution occurring on the para-methyl group. Further, the isobutylene-co-paramethylstyrene copolymer in hydrocarbon solvents (e.g., pentane, hexane, or heptane) can be selectively brominated using light, heat, or selected radial initiators as promotors of radical halogenation. For instance, U.S. Pat. No. 5,162,445, incorporated entirety herein by reference, discloses halogenation reactions that can be performed to functionalize the isobutylene-co-paramethylstyrene based elastomers described herein. In various embodiments, halogenated isobutylene-co-paramethylstyrene based elastomers can comprise at least 0.25 wt % (e.g., from about 0.25 wt % to about 4 wt %) of the halogen. Expressed another way, the halogenated isobutylene-co-paramethylstyrene based elastomers can comprise from about 0.1 to about 7.5 mole percent of halogenated paramethylstyrene derived units. For example, suitable halogenated isobutylene-co-paramethylstyrene based elastomers can include elastomers that are commercially available as Exxpro™ elastomers (ExxonMobil Product Solutions Company, Houston TX), and abbreviated as “BIMSM,” such as: Exxpro™ 3035 (e.g., comprising about 0.47 mole percent of benzylic bromine), 3433 (e.g., comprising about 0.75 mole percent of benzylic bromine), 3563 (e.g., comprising about 0.85 mole percent of benzylic bromine), and/or 3745 (e.g., comprising about 1.2 mole percent of benzylic bromine).

### Peroxide Treatment Based MWD Modification

In processing the isobutylene-co-paramethylstyrene based elastomers it is desirable to improve mechanical properties while maintaining, or improving, processability properties. Such properties can be a function of molecular weight and can include, for example: extrusion rate, die swell, mixing time, filler dispersion, cold flow, green strength, tire cord strike-through, building tack, adhesion, stress relaxation rates, and/or various vulcanizate properties. However, various properties can have conflicting relationships with the molecular weight of the elastomer. For instance, as the molecular weight of the elastomer increases, the green strength value improves while the stress relaxation rate diminishes (e.g., slows). Green strength can characterize the elastomer's ability to resist excessive flow and deformation during various handling and/or processing operations. Stress relaxation rates can characterize the elastomer's ability to relax after being subjected to stress; thereby enabling the elastomer to avoid shape changes. Thus, as the isobutylene-co-paramethylstyrene based elastomers become better able to resist flow and deformation in the various handling operations, they also become more prone to changing shape or pull apart due unrelaxed stresses. Furthermore, increasing molecular weight in order to increase green strength can make it more difficult to process the elastomer and to disperse fillers and additives.

However, various embodiments described herein can enable an improved compromise between various conflicting properties desired in elastomer formation during processing, fabrication, and/or end-use in one or more applications. For example, improved mechanical properties (e.g., green strength) and processability (e.g., stress relaxation rates) for the isobutylene-co-paramethylstyrene based elastomers can be achieved by broadening the MWD of the elastomers. For example, the isobutylene-co-paramethylstyrene based elastomers can be produced with a high molecular weight to improve the mechanical properties, whereupon one or more post polymerization modifications can increase the low molecular weight fraction of the elastomers to improve the processability (e.g., stress relaxation rates).

For example, various synthesis methods described herein can produce isobutylene-co-paramethylstyrene based elastomer compositions that exhibit increased green strength values and faster stress relaxation rates. Such compositions can be particularly useful in products such as: tire components (e.g., tire innerliners and/or tire cure bladders), innertubes, wire and/or cable components, hoses, films, automotive and/or mechanical goods, sponge products, pharmaceuticals (e.g., pharmaceutical rubber stoppers), adhesives, sealants, and/or the like.

In various embodiments, the isobutylene-co-paramethylstyrene based elastomers can be subjected to one or more post-polymerization peroxide treatments to modify the MWD. The post-polymerization peroxide treatment can utilize chemical and thermal cracking of the copolymer backbone to increase the low molecular weight fraction of the copolymer composition. For example, the isobutylene-co-paramethylstyrene based elastomers can be treated with a peroxide initiator at a temperature ranging from, for example, about 150 °C to about 220 °C (e.g., from about 160 °C to about 190 °C) in a melt mixer. Suitable peroxides can have a decomposition temperature greater than about 130 °C (e.g., greater than 140 °C) and/or be an organic peroxide having a 10 hour half-life temperature greater than about 110 °C. Example peroxides suitable for use in the peroxide treatment include, but are not limited to: dicumyl peroxide; 2,5-Bis(tert-butylperoxy)-2,5-dimethylhexane; dicumyl peroxide; alpha, alpha-bis(t-butylperoxy)diisopropylbenzene; 2,5-dimethyl-2,5-di(t-butylperoxy) hexane; t-butyl cumyl peroxide; di-t-butyl peroxide; 2,5-dimethyl-2,5-di(-t-butylperoxy) hexyne, and/or mixtures thereof; organic peroxides such as dialkylperoxides, ketalperoxides, aralkylperoxides, peroxide ethers, peroxide esters, such as di-tert.-butylperoxide, bis-(tert.-butylperoxyisopropyl)-benzene, dicumylperoxide, 2,5-dimethyl-2,5-di(tert.-butylperoxy)-hexane, 2,5-dimethyl-2,5-di(tert.-butylperoxy)-hexene-(3), 1,1-bis-(tert.-butylperoxy)-3,3,5-trimethyl-cyclohexane, benzoylperoxide, tert.-butylcumylperoxide and tert.-butylperbenzoate; a combination thereof and/or the like. The amount of peroxide initiator can range from, for example, about 0.2 to about 4.5 wt %, based on the amount of isobutylene-co-paramethylstyrene based elastomer. In various embodiments, the amount of peroxide initiator utilized in the MDW modification can increase as the concentration of halogen increases in the isobutylene-co-paramethylstyrene based elastomer. For example, the post polymerization peroxide treatment can be performed prior to the halogenation reactions described herein or subsequent to the halogenation reactions (e.g., prior or post a bromination reaction).

In one or more embodiments, the peroxide treatment can result in a modified isobutylene-co-paramethylstyrene based elastomer having a high fraction of low molecular weight species (as compared to the isobutylene-co-paramethylstyrene based elastomer prior to the peroxide treatment); thereby broadening the copolymer's MWD. For example, the peroxide treatment can chemically induce a thermal breaking along the copolymer backbone of the isobutylene-co-paramethylstyrene based elastomer to increase the fraction of low molecular weight species. The modified isobutylene-co-paramethylstyrene based elastomer can have a Mw ranging from, for example, about 10,000 Da to about 1,000,000 Da (e.g., from about 25,000 Da to about 500,000 Da). In some examples, the modified isobutylene-co-paramethylstyrene based elastomer can have a Mn less than 150,000 Da, less than 100,000 Da, or less than 50,000 Da. The low molecular weight species can have a molecular weight ranging from, for example, about 10,000 Da to about 200,000 Da (e.g., from about 25,000 Da to about 100,000 Da). For instance, the peroxide treatment can increase the low molecular weight fraction to a range of about 20 Da to about 60 Da (e.g., from about 20 Da to about 40 Da). Thereby, the modified isobutylene-co-paramethylstyrene based elastomer can have a MWD ranging from, for example, about 2.5 to 10 (e.g., from 6.1 to 10).

In various embodiments, the modified isobutylene-co-paramethylstyrene based elastomer can further comprise one or more branch moieties resulting from one or more coupling reactions occurring from the peroxide treatment. For example, the modified isobutylene-co-paramethylstyrene based elastomers described herein can have branched structures formed by the incorporation (e.g., during the peroxide treatment process) of crosslinking or cationically active co-monomers and/or agents, referred to herein as “branching agents.” The introduction of branching (e.g., long chain branching) can result in further modification to the polymer's molecular weight, and thus the amount of branching can be controlled to achieve a desired MWD (e.g., to achieve a desired MWD that can subsequently be broadened by one or more peroxide treatments described herein). For example, the MWD of the modified isobutylene-co-paramethylstyrene based elastomer (unmodified by one or more peroxide treatments) can further be a function of linear fractions of the polymer versus branched fractions of the polymer.

Where branching agents are employed to promote crosslinking reactions, randomized long chain branching can occur to modify the entire MWD of the isobutylene-co-paramethylstyrene based elastomer. In contrast, soluble moieties containing multiple reactive sites can be employed as the branching agent to introduce a controlled amount of a high molecular weight branched fraction into the distribution without modifying the entire molecular weight distribution of the polymer. For example, a small amount of a very highly functional and reactive soluble moiety can be used to introduce a small amount of very high molecular weight highly branched material into the distribution. Alternatively, a larger amount of a less reactive, lower functionality moiety can be used to introduce more of the branched fraction, but of lower molecular weight.

In various embodiments, the cationically reactive branching agents can be present during polymerization process in an amount effective for producing desired changes in MWD (e.g., which can later serve as the high molecular weight component in one or more blended compositions). The amount of cationically reactive branching agents can vary depending on the number and reactivity of the cationically active species, including such variables as molecular weight and reactivity of the agent (particularly that portion of the agent containing the cationically active moiety). Additionally, polymerization conditions can influence the effective concentration (e.g., batch versus continuous, temperature, monomer conversion, and/or the like). In one or more embodiments, the amount of cationically reactive branching agents can range from, for example, about 0.3 to about 3.0 weight percent, based on the monomers.

### Blended Compositions

In various embodiments, the modified isobutylene-co-paramethylstyrene based elastomers (e.g., subjected to the peroxide treatment) can be mixed with unmodified isobutylene-co-paramethylstyrene elastomers (e.g., not subjected to the peroxide treatment) to form a blended composition. For example, blending modified and unmodified elastomers can further control the MWD. For instance, the modified isobutylene-co-paramethylstyrene elastomers and the unmodified isobutylene-co-paramethylstyrene based elastomers can have widely different and defined molecular weights; with the modified isobutylene-co-paramethylstyrene based elastomers contributing low molecular weight species to the blended composition, and the unmodified isobutylene-co-paramethylstyrene based elastomers contributing the majority of the high molecular weight species. By controlling the ratio of modified isobutylene-co-paramethylstyrene based elastomer to unmodified isobutylene-co-paramethylstyrene based elastomer, a tailor-made MWD can be achieved. By broadening the MWD (e.g., as compared to compositions of just the unmodified isobutylene-co-paramethylstyrene based elastomers) the blended composition can maintain, or improve, the polymer's mechanical properties (e.g., green strength levels) while also improving the polymer's processability (e.g., increasing the stress relaxation rate).

In one or more embodiments, the effects of blending the modified isobutylene-co-paramethylstyrene based elastomers and unmodified isobutylene-co-paramethylstyrene based elastomers can be achieved via a direct synthesis process by utilizing the polymer product of two or more reactors (e.g., operating in parallel or series) or polymerization zones (e.g., of a single reactor). For instance, each zone, or reactor, can produce a polymer (e.g., modified isobutylene-co-paramethylstyrene based elastomers or unmodified isobutylene-co-paramethylstyrene based elastomers) with molecular weight characteristics desired for the final product, where blending the polymer products together can achieve a target MWD and/or incorporate desired characteristics (e.g., mechanical and/or processability properties). For example, the blended compositions described herein can have a MWD ranging from 2.5 to 10.0.

For example, a blending ratio of unmodified isobutylene-co-paramethylstyrene based elastomer to modified isobutylene-co-paramethylstyrene based elastomer can range from, for example, about 0.1:1 to about 1:0.1. In various embodiments, the blended composition can have a low molecular weight fraction (e.g., characterizing the amount of species having a molecular weight less than 100,000 Da) ranging from, for example, about 10 wt % to about 90 wt %; and a high molecular weight fraction (e.g., characterizing the amount of species having a molecular weight greater than 100,000 Da) ranging from, for example, about 10 wt % to about 90 wt %.

The various embodiments and/or features described herein can be practiced in various orders. For example, the peroxide treatment can be applied to isobutylene-co-paramethylstyrene based elastomers before or after halogenation. For instance, modified isobutylene-co-paramethylstyrene based elastomers, or blended compositions thereof, can be subsequently halogenated to achieve the various halogen composition characteristics described herein.

In a first example order, the synthesis methodology of one or more embodiments described herein can be employed to synthesize a non-blended, non-halogenated isobutylene-co-paramethylstyrene based elastomer with a MWD ranging from 2.5 to 10.0 (e.g., 6.1 to 10). For instance, the synthesis can comprise treating a non-halogenated isobutylene-co-paramethylstyrene based elastomer with the peroxide treatment (e.g., at 160 °C to 190 °C) to achieve the desired MWD.

In a second example order, the synthesis methodology of one or more embodiments described herein can be employed to synthesize a blended, non-halogenated isobutylene-co-paramethylstyrene based elastomer composition with a MWD ranging from 2.5 to 10.0 (e.g., 6.1 to 10). For instance, the synthesis can comprise: treating a non-halogenated isobutylene-co-paramethylstyrene based elastomer with the peroxide treatment (e.g., at 160 °C to 190 °C) to achieve a modified non-halogenated isobutylene-co-paramethylstyrene based elastomer; and blending the modified non-halogenated isobutylene-co-paramethylstyrene based elastomer with a non-modified isobutylene-co-paramethylstyrene based elastomer (e.g., having substantially the same composition as the non-halogenated isobutylene-co-paramethylstyrene based elastomer previously treated) to achieve a blended composition with the desired MWD.

In a third example order, the synthesis methodology of one or more embodiments described herein can be employed to synthesize a non-blended, halogenated isobutylene-co-paramethylstyrene based elastomer with a MWD ranging from 2.5 to 10.0 (e.g., 6.1 to 10). For instance, the synthesis can comprise: treating a non-halogenated isobutylene-co-paramethylstyrene based elastomer with the peroxide treatment (e.g., at 160 °C to 190 °C) to achieve a modified non-halogenated isobutylene-co-paramethylstyrene based elastomer; and treating the modified non-halogenated isobutylene-co-paramethylstyrene based elastomer to a halogenation reaction to achieve a modified halogenated isobutylene-co-paramethylstyrene based elastomer with the desired MWD.

In a fourth example order, the synthesis methodology of one or more embodiments described herein can be employed to synthesize another non-blended, halogenated isobutylene-co-paramethylstyrene based elastomer with a MWD ranging from 2.5 to 10.0 (e.g., 6.1 to 10). For instance, the synthesis can comprise treating a halogenated isobutylene-co-paramethylstyrene based elastomer with the peroxide treatment (e.g., at 160 °C to 190 °C) to achieve the desired MWD.

In a fifth example order, the synthesis methodology of one or more embodiments described herein can be employed to synthesize a blended, halogenated isobutylene-co-paramethylstyrene based elastomer composition with a MWD ranging from 2.5 to 10.0 (e.g., 6.1 to 10). For instance, the synthesis can comprise: treating a non-halogenated isobutylene-co-paramethylstyrene based elastomer with the peroxide treatment (e.g., at 160 °C to 190 °C) to achieve a modified non-halogenated isobutylene-co-paramethylstyrene based elastomer; blending the modified non-halogenated isobutylene-co-paramethylstyrene based elastomer with a non-modified isobutylene-co-paramethylstyrene based elastomer (e.g., having substantially the same composition as the non-halogenated isobutylene-co-paramethylstyrene based elastomer previously treated) to achieve a blended composition; and treating the blended composition to a halogenation reaction described herein to achieve a blended, halogenated isobutylene-co-paramethylstyrene based elastomer with the desired MWD.

In a sixth example order, the synthesis methodology of one or more embodiments described herein can be employed to synthesize another blended, halogenated isobutylene-co-paramethylstyrene based elastomer composition with a MWD ranging from 2.5 to 10.0 (e.g., 6.1 to 10). For instance, the synthesis can comprise: treating a non-halogenated isobutylene-co-paramethylstyrene based elastomer with the peroxide treatment (e.g., at 160 °C to 190 °C) to achieve a modified non-halogenated isobutylene-co-paramethylstyrene based elastomer; treating the modified non-halogenated isobutylene-co-paramethylstyrene based elastomer to a halogenation reaction; and blending the modified halogenated isobutylene-co-paramethylstyrene based elastomer with a non-modified isobutylene-co-paramethylstyrene based elastomer (e.g., halogenated or non-halogenated) to achieve a blended, halogenated isobutylene-co-paramethylstyrene based elastomer with the desired MWD.

In a seventh example order, the synthesis methodology of one or more embodiments described herein can be employed to synthesize another blended, halogenated isobutylene-co-paramethylstyrene based elastomer composition with a MWD ranging from 2.5 to 10.0 (e.g., 6.1 to 10). For instance, the synthesis can comprise treating a halogenated isobutylene-co-paramethylstyrene based elastomer with the peroxide treatment (e.g., at 160 °C to 190 °C) to achieve a modified halogenated isobutylene-co-paramethylstyrene based elastomer; and blending the modified halogenated isobutylene-co-paramethylstyrene based elastomer with a non-modified isobutylene-co-paramethylstyrene based elastomer (e.g., having substantially the same composition as the halogenated isobutylene-co-paramethylstyrene based elastomer previously treated) to achieve a blended composition with the desired composition.

### Additional Embodiments

Non-limiting example embodiments of the present disclosure include:

Embodiment A: A method for preparing an isobutylene-co-paramethylstyrene composition, the method comprising: treating an isobutylene-co-paramethylstyrene based elastomer with a peroxide initiator at a temperature greater than or equal to 160 °C to chemically induce a thermal breaking along the copolymer backbone of the isobutylene-co-paramethylstyrene based elastomer, where the treating produces a modified isobutylene-co-paramethylstyrene based elastomer having a Mw/Mn ratio greater than 2.5.

Non-limiting example embodiment A can include one or more of the following elements.

Element 1A: wherein the treating comprises an amount of the peroxide initiator ranging from 0.2 to 4.5 weight percent, based on the isobutylene-co-paramethylstyrene based elastomer.

Element 2A: wherein the temperature ranges from 160 to 190 °C.

Element 3A: wherein the isobutylene-co-paramethylstyrene based elastomer comprises 80 to 99.5 mole percent of isobutylene and 0.5 to 20 mole percent of paramethylstyrene.

Element 4A: wherein the isobutylene-co-paramethylstyrene based elastomer comprises 5 mole percent of the paramethylstyrene.

Element 5A: wherein the isobutylene-co-paramethylstyrene based elastomer has an average molecular weight (Mw) ranging from, for example, about 200,000 to about 2,000,000 Daltons.

Element 6A: wherein the isobutylene-co-paramethylstyrene based elastomer has a Mw/Mn ratio less than 2.5.

Element 7A: wherein the isobutylene-co-paramethylstyrene based elastomer has a Mw/Mn ratio less than 2.0.

Element 8A: further comprising: blending the modified isobutylene-co-paramethylstyrene based elastomer with an amount of the isobutylene-co-paramethylstyrene based elastomer to control a Mw/Mn ratio of the isobutylene-co-paramethylstyrene composition.

Element 9A: wherein the blending is performed with a blending ratio of the isobutylene-co-paramethylstyrene based elastomer to the modified isobutylene-co-paramethylstyrene based elastomer that ranges from 0.5:1.0 to 2.0:1.0.

Element 10A: wherein the blending ratio is 1:1.

Element 11A: wherein the Mw/Mn ratio of the isobutylene-co-paramethylstyrene composition is at least two times greater than the Mw/Mn ratio of the isobutylene-co-paramethylstyrene based elastomer.

Element 12A: wherein the Mw/Mn ratio of the isobutylene-co-paramethylstyrene composition ranges from 6.0 to 10.0.

Element 13A: wherein the isobutylene-co-paramethylstyrene based elastomer is halogenated prior to the treating with the peroxide initiator.

Element 14A: further comprising: halogenating the modified isobutylene-co-paramethylstyrene based elastomer.

Element 15A: further comprising: halogenating the modified isobutylene-co-paramethylstyrene based elastomer prior to the blending.

Element 16A: further comprising: halogenating the modified isobutylene-co-paramethylstyrene based elastomer subsequent to the blending.

Each of Elements 1A through 16A can be combined in any combination, without limitation.

Embodiment B: A method for preparing an isobutylene-co-paramethylstyrene based elastomer, the method comprising: increasing a low molecular weight fraction of an isobutylene-co-paramethylstyrene based elastomer by mixing the isobutylene-co-paramethylstyrene based elastomer with a peroxide initiator at a temperature greater than or equal to 160 °C, where the mixing produces a modified isobutylene-co-paramethylstyrene based elastomer having a Mw/Mn ratio greater than 2.5.

Non-limiting example embodiment B can include one or more of the following elements.

Element 1B: wherein the isobutylene-co-paramethylstyrene based elastomer is a non-halogenated elastomer, a halogenated elastomer, a branched elastomer, or a combination thereof.

Element 2B: wherein the isobutylene-co-paramethylstyrene based elastomer comprises 80 to 99.5 mole percent of isobutylene and 0.5 to 20 mole percent of paramethylstyrene.

Element 3B: further comprising: blending the modified isobutylene-co-paramethylstyrene based elastomer with an amount of the isobutylene-co-paramethylstyrene based elastomer to control a Mw/Mn ratio of the isobutylene-co-paramethylstyrene composition.

Element 4B: wherein the blending is performed with a blending ratio of the isobutylene-co-paramethylstyrene based elastomer to the modified isobutylene-co-paramethylstyrene based elastomer that ranges from 0.5:1.0 to 2.0:1.0.

Each of Elements 1B through 4B can be combined in any combination, without limitation.

Embodiment C: An isobutylene-co-paramethylstyrene based elastomer comprising 80 to 99.5 mole percent of isobutylene and 0.5 to 20 mole percent of paramethylstyrene, having a substantially homogenous compositional distribution, and having a Mw/Mn ratio greater than 6.0.

Non-limiting example embodiment C can include one or more of the following elements.

Element 1C: wherein the paramethylstyrene is represented by the formula:

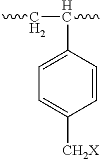

wherein X is hydrogen or a halogen.

Element 2C: wherein X is bromine.

Element 3C: A cured article comprising the isobutylene-co-paramethylstyrene based elastomer of embodiment C, wherein the cured article is a tire innerliner, an innertube, a wire coating, a pharmaceutical rubber stopper, a hose, a film, an adhesive, or a sealant.

Each of Elements 1C through 3C can be combined in any combination, without limitation.

To facilitate a better understanding of the embodiments described herein, the following examples are provided. In no way should the following examples be read to limit, or to define, the scope of the present disclosure.

### EXAMPLES

Various isobutylene-co-paramethylstyrene based elastomer were synthesized in accordance with or more embodiments described herein and analyzed using GPC and/or FTIR techniques to determine the associated MWDs. One of ordinary skill in the art will recognize that reactors that are typically used in butyl rubber polymerizations are generally suitable for use in the various polymerization and/or MWD modification reactions described herein.

### Gel Permeation Chromatography (GPC) Molecular Weight

GPC is an analytical procedure used for separating molecules by differences in size. The procedure as applied to polymers results in a concentration distribution of molecular weights. Most often, concentration is determined using differential refractive index (DRI) and the concentration v. time elution curve is related to molecular weight by means of a calibration curve based on a “known” standard. Utilizing low-angle laser light-scattering (LALLS) photometry in conjunction with DRI, direct determination of molecular weight can be made.

Molecular weight averages can be calculated based on the data obtained from a GPC test. Molecular weight averages include: number average (Mn), weight average (Mw) and Z-average (Mz). These averages are also referred to as the various moments of the distribution. Higher molecular weight species have a greater influence on the Z and weight averages whereas lower molecular weight species more greatly influence the number average. The breadth of the distribution overall as well as parts of it can be characterized by reference to various ratios, e.g., Mw/Mn and Mz/Mw; the higher the values of the ratio, the broader the distribution of molecular weights.

Molecular weights (weight average molecular weight (Mw) and number average molecular weight (Mn)) and molecular weight distribution (MWD=Mw/Mn), which is also sometimes referred to as the polydispersity index (PDI) of the polymer, were measured by GPC. Molecular weights were determined by Tosoh BioScience HLC-8320 GPC equipped with an internal DRI detector, an internal UV absorbance detector UV-8320 (254 nm absorbance Detector), a Wyatt Technology miniDawn TREOS light scattering detector with three angles (45°, 90°, and 135°), and a Wyatt Technology ViscoStar-II viscometer detector, a series of three of Polymer Labs PLgel Mixed-B with peak Mw; range of 580-10,000,000. The columns were calibrated using Polymer Labs EasiVial polystyrene standards (high, medium, and low) standards. Approximately 20 mg of polymer dissolved in 10 mL tetrahydrofuran (“THF”) stabilized with butylated hydroxyl toluene (“BHT”) and with toluene as a flow marker, the solution was filtered by using a 0.45 μm Acrodisc filter (membrane type PTFE), and 150 μL samples were injected by the auto injector. Testing conditions: sample solvent: tetrahydrofuran containing 250-400 ppm of butylated hydroxyl toluene; sample concentration: 2.0 mg/mL; sample dissolution temperature: room temp (~23 °C); sample dissolution time: 3 hours minimum on dissolving wheel; GPC pump oven and column oven temperatures: 40 °C; Flow rate: 1 mL/min; mobile phase solvent: THF (same as sample solvent); sample injection size: 150 μL; sample elution time: 65 minutes. The Wyatt Technology's Astra 6.1 GPC software was used for data analysis. The universal calibration curve methodology data was primarily used for reporting the results. For detailed understanding of the molecular weights of the elastomers, the on-line light scattering measurements, using the laser light scattering (“LLS”) detector connected on-line with the columns and other detectors were used. The dn/dc value for butyl rubber, 0.113 mL/g, was used for calculating the absolute molecular weights. Samples for light scattering were prepared with care to avoid the presence of particulate matter. The Wyatt Technology's Astra 6.1 GPC software was used for data analysis.

The quantification of the functional groups, the percent incorporation of paramethylstyrene and brominated paramethylstyrene (BrpMS) in the elastomer, and other components or additives present were determined using a PerkinElmer Frontier FTIR spectrometer with triglycine sulfate (TGS) detector and a sample shuttle. The spectrometer was controlled by the Spectrum™ 10.6.0 software. The infrared spectra of elastomers were acquired using a compression molded film specimen of thickness 0.060 cm, using an automated Carver Hydraulic Press. FTIR spectra were collected at 4 cm⁻¹ resolution with 16 scans, scan range 6525-400 cm⁻¹. All FTIR spectra were normalized against a common region 4400-4250 cm⁻¹, and the base absorbance measured at 4980-2040 cm⁻¹. The paramethylstyrene concentration was quantified using an aromatic overtone band centered at 1894 cm⁻¹, and brominated paramethylstyrene units were quantified using the C—Br band centered 615 cm⁻¹. Spectral regions corresponding to structures or components of interest were correlated with their concentrations determined according to Beer's Law and multipoint calibrations to cover the range of paramethylstyrene and brominated paramethylstyrene concentrations, the calibration sets were prepared from standards with known concentration obtained by NMR. A model was developed to automatically calculate the mol % of paramethylstyrene and mol % brominated paramethylstyrene after the spectrum was collected.

### Example 1

In a first example set, the non-halogenated isobutylene-co-paramethylstyrene based elastomer XP-50, commercially available from Exxon™, was modified via the peroxide treatment described herein, where a Di-Cup® was utilized as the peroxide initiator. Table 1, shown below, illustrates the composition of three example isobutylene-co-paramethylstyrene based elastomer (e.g., Elastomers 1-3). To achieve the compositions characterized in Table 1, the XP-50 was mixed with varying amounts of Di-Cup® in a 280 gram mixing bowl at about 100 °C. The temperature was then raised to 190 °C and the batch was further mixed for 5 minutes.

TABLE 1
Example Elastomer Composition

| | XP-50 | | | | |
|---|---|---|---|---|---|
| T = 190 °C | (parts per | | | XP-50 | |
| Mix for 5 | hundred | Di-Cup ® | Total | (grams | Di-Cup ® |
| minutes | (phr)) | (phr) | phr | (g)) | (g) |
| Elastomer 1 | 100.0 | 2.0 | 102.0 | 274.51 | 5.49 |
| Elastomer 2 | 100.0 | 3.0 | 103.0 | 271.84 | 8.16 |
| Elastomer 3 | 100.0 | 4.0 | 104.0 | 269.23 | 10.77 |

Additionally, Table 2 presents the molecular weight and MWD data for the example isobutylene-co-paramethylstyrene based elastomers (e.g., Elastomers 1-3), as determined using a light scattering detector. Further, Table 3 presents the molecular weight and MWD data for the example isobutylene-co-paramethylstyrene based elastomers (e.g., Elastomers 1-3), as determined using an universal calibration with inline viscometer data.

TABLE 2
Light Scatter Detector

| | Mn | Mw | Mz | |
|---|---|---|---|---|
| | (kDa) | (kDa) | (kDa) | Mw/Mn |
| XP-50 | 234.2 | 417.3 | 625.8 | 1.8 |
| Elastomer 1 | 61.8 | 177.8 | 624.2 | 2.9 |
| Elastomer 2 | 62.3 | 176.3 | 621.3 | 2.8 |
| Elastomer 3 | 59.5 | 173.3 | 809.0 | 2.9 |
| Elastomer 1-Br* | 63.6 | 191.1 | 545.9 | 3.0 |
| Elastomer 2-Br* | 66.7 | 196.5 | 658.8 | 2.9 |
| Elastomer 3-Br* | 62.1 | 191.1 | 774.8 | 3.1 |

*The elastomer was brominated post MWD modification.

TABLE 3
Universal Calibration

| | Mn | Mw | Mz | |
|---|---|---|---|---|
| | (kDa) | (kDa) | (kDa) | Mw/Mn |
| XP-50 | 187.3 | 406.2 | 661.1 | 2.2 |
| Elastomer 1 | 64.1 | 159.3 | 421.8 | 2.5 |
| Elastomer 2 | 58.6 | 151.0 | 388.9 | 2.6 |
| Elastomer 3 | 46.9 | 137.0 | 452.7 | 2.9 |
| Elastomer 1-Br* | 63.8 | 165.7 | 379.4 | 2.6 |
| Elastomer 2-Br* | 55.0 | 162.5 | 437.6 | 3.0 |
| Elastomer 3-Br* | 46.0 | 147.7 | 455.0 | 3.2 |

*The elastomer was brominated post MWD modification.

Further, the brominated example elastomers (e.g., Elastomer 1-Br, Elastomer 2-Br, and Elastomer 3-Br) were blended with a non-halogenated isobutylene-co-paramethylstyrene based elastomer, refer to herein as “Comparative Elastomer A”, at various blending ratios (Comparative Elastomer A to brominated example elastomer). Table 4 depicts the molecular weight and MWD data for the elastomers, as determined by the light scattering detector. Table 5 depicts the molecular weight and MWD data for the elastomers, as determined using a universal calibration with inline viscometer data. For comparison, Tables 4-5 also include the molecular weight and MWD for the unmodified Comparative Elastomer A isobutylene-co-paramethylstyrene based elastomer, which is the brominated embodiment of XP-50.

TABLE 4
Light Scattering Detector

| | Blend | Mn | Mw | Mz | |
|---|---|---|---|---|---|
| | Ratio* | (kDa) | (kDa) | (kDa) | Mw/Mn |
| Comparative Elastomer A | N/A | 774.9 | 1683.7 | 3058.4 | 2.2 |
| Comparative Elastomer A + | .66:1 | 136.6 | 812.3 | 2619.9 | 5.9 |
| Elastomer 1-Br | | | | | |
| Comparative Elastomer A + | 1:1 | 164.5 | 917.7 | 2470.1 | 5.6 |
| Elastomer 1-Br | | | | | |
| Comparative Elastomer A + | 1.5:1 | 204.4 | 982.0 | 2224.5 | 4.8 |
| Elastomer 1-Br | | | | | |
| Comparative Elastomer A + | .66:1 | 127.1 | 787.2 | 2443.2 | 6.2 |
| Elastomer 2-Br | | | | | |
| Comparative Elastomer A + | 1:1 | 141.1 | 917.4 | 2523.8 | 6.5 |
| Elastomer 2-Br | | | | | |
| Comparative Elastomer A + | 1.5:1 | 189.0 | 1044.9 | 2497.3 | 5.5 |
| Elastomer 2-Br | | | | | |
| Comparative Elastomer A + | .66:1 | 138.3 | 779.0 | 2268.8 | 5.6 |
| Elastomer 3-Br | | | | | |
| Comparative Elastomer A + | 1:1 | 147.9 | 907.4 | 2369.3 | 6.1 |
| Elastomer 3-Br | | | | | |
| Comparative Elastomer A + | 1.5:1 | 167.6 | 1063.1 | 2536.0 | 6.3 |
| Elastomer 3-Br | | | | | |

*Blend ratio = Comparative Elastomer A to example elastomer.

TABLE 5
Universal Calibration

| | Blend | Mn | Mw | Mz | |
|---|---|---|---|---|---|
| | Ratio* | (kDa) | (kDa) | (kDa) | Mw/Mn |
| Comparative Elastomer A | N/A | 567.6 | 1304.4 | 2405.1 | 2.3 |
| Comparative Elastomer A + | .66:1 | 100.7 | 697.5 | 2270.6 | 6.9 |
| Elastomer 1-Br | | | | | |
| Comparative Elastomer A + | 1:1 | 116.3 | 826.0 | 2359.5 | 7.1 |
| Elastomer 1-Br | | | | | |
| Comparative Elastomer A + | 1.5:1 | 137.2 | 921.7 | 2351.7 | 6.7 |
| Elastomer 1-Br | | | | | |
| Comparative Elastomer A + | .66:1 | 89.1 | 713.0 | 2352.7 | 8.0 |
| Elastomer 2-Br | | | | | |
| Comparative Elastomer A + | 1:1 | 103.9 | 840.7 | 2443.7 | 8.1 |
| Elastomer 2-Br | | | | | |
| Comparative Elastomer A + | 1.5:1 | 128.1 | 937.2 | 2394.4 | 7.3 |
| Elastomer 2-Br | | | | | |
| Comparative Elastomer A + | .66:1 | 74.0 | 705.9 | 2355.1 | 9.5 |
| Elastomer 3-Br | | | | | |
| Comparative Elastomer A + | 1:1 | 88.5 | 824.7 | 2374.0 | 9.3 |
| Elastomer 3-Br | | | | | |
| Comparative Elastomer A + | 1.5:1 | 110.0 | 952.4 | 2402.8 | 8.7 |
| Elastomer 3-Br | | | | | |

*Blend ratio = Comparative Elastomer A to example elastomer.

Table 6, presented below, includes the FTIR data of the brominated MWD modified example elastomers (e.g., Elastomer 1-Br, Elastomer 2-Br, Elastomer 3-Br). In particular, Table 6 depicts the mole percent of the brominated and non-brominated paramethylstyrene (“PMS”) component of the example elastomer.

TABLE 6
FTIR Data

| | Br-PMS | PMS | Water | Stearic Acid |
|---|---|---|---|---|
| | Mol % | Mol % | Wt % | Wt % |
| Elastomer 1-Br | 0.458 | 3.073 | 0.15 | 0.15 |
| Elastomer 2-Br | 0.304 | 3.115 | 0.11 | 0.11 |
| Elastomer 3-Br | 0.189 | 3.108 | 0.23 | 0.16 |

### Example 2

In a second example set, the brominated isobutylene-co-paramethylstyrene based elastomers Exxpro™ 3035 and Exxpro™ 3745, commercially available from Exxon™, were modified via the peroxide treatment described herein (e.g., bromination of the isobutylene-co-paramethylstyrene based elastomers was performed pre MWD modification by the peroxide treatment), where a Di-Cup® was utilized as the peroxide initiator. Table 7, shown below, illustrates the composition of six example isobutylene-co-paramethylstyrene based elastomers (e.g., Elastomers 4-9). To achieve the compositions characterized in Table 7, Exxpro™ 3035 or Exxpro™ 3745 was mixed with varying amounts of Di-Cup® in a 280 gram mixing bowl at about 100 °C. The temperature was then raised to 190 °C and the batch was further mixed for 5 minutes.

TABLE 7
Example Elastomer Compositions

| T = 190 °C | Exxpro ™ | Exxpro ™ | Di- | | Exxpro ™ | Exxpro ™ | Di- |
|---|---|---|---|---|---|---|---|
| Mix for 5 | 3035 | 3745 | Cup ® | Total | 3035 | 3745 | Cup ® |
| minutes | (phr) | (phr) | (phr) | phr | (g) | (g) | (g) |
| Elastomer 4 | 100.0 | 0 | 2.0 | 102.0 | 254.90 | 0 | 5.10 |
| Elastomer 5 | 100.0 | 0 | 3.0 | 103.0 | 252.43 | 0 | 7.57 |
| Elastomer 6 | 100.0 | 0 | 4.0 | 104.0 | 250.0 | 0 | 10.00 |
| Elastomer 7 | 0 | 100.0 | 2.0 | 102.0 | 0 | 254.90 | 5.10 |
| Elastomer 8 | 0 | 100.0 | 3.0 | 103.0 | 0 | 252.43 | 7.57 |
| Elastomer 9 | 0 | 100.0 | 4.0 | 104.0 | 0 | 250.00 | 10 |

Additionally, Table 8 presents the molecular weight and MWD data for the example isobutylene-co-paramethylstyrene based elastomers (e.g., Elastomers 4-9), as determined using a light scattering detector. Further, Table 9 presents the molecular weight and MWD data for the example isobutylene-co-paramethylstyrene based elastomers (e.g., Elastomers 4-9), as determined using an universal calibration with inline viscometer data.

TABLE 8
Light Scatter Detector

| | Mn | Mw | Mz | |
|---|---|---|---|---|
| | (kDa) | (kDa) | (kDa) | Mw/Mn |
| Exxpro ™ 3035 | 237.1 | 421.85 | 644.05 | 1.8 |
| Elastomer 4 | 58.4 | 476.3 | 3348.45 | 8.2 |
| Exxpro ™ 3745 | 221.6 | 395.6 | 594.7 | 1.8 |
| Elastomer 7 | 30.8 | 213.4 | 1627.1 | 6.9 |
| Elastomer 8 | 38.0 | 181.1 | 1037.1 | 4.8 |
| Elastomer 9 | 24.8 | 134.9 | 737.1 | 5.4 |

TABLE 9
Universal Calibration

| | Mn | Mw | Mz | |
|---|---|---|---|---|
| | (kDa) | (kDa) | (kDa) | Mw/Mn |
| Exxpro ™ 3035 | 191.9 | 398.6 | 643.3 | 2.1 |
| Elastomer 4 | 73.3 | 302.8 | 1130.0 | 4.1 |
| Exxpro ™ 3745 | 182.0 | 382.4 | 612.4 | 2.1 |
| Elastomer 7 | 62.0 | 184.7 | 559.8 | 3.0 |
| Elastomer 8 | 49.7 | 147.1 | 431.9 | 3.0 |
| Elastomer 9 | 42.8 | 120.5 | 386.6 | 2.8 |

Further, Table 10 includes the FTIR data of Exxpro™ 3035 and Elastomer 4. In particular, Table 10 depicts the mole percent of the brominated and non-brominated paramethylstyrene (“PMS”) component of the elastomers.

TABLE 10
FTIR Data

| | Br-PMS | PMS | Water | Stearic Acid |
|---|---|---|---|---|
| | Mol % | Mol % | Wt % | Wt % |
| Exxpro ™ 3035 | 0.461 | 2.06 | 0.06 | 0.06 |
| Elastomer 4 | 0.063 | 2.13 | 0.12 | 0.67 |

### Example 3

In a third example set, the brominated isobutylene-co-paramethylstyrene based elastomer Exxpro™ 3035, commercially available from Exxon™, was modified via the peroxide treatment described herein, where Di-Cup® or Luperox® 101 were utilized as the peroxide initiator. Table 11, shown below, illustrates the composition of six example isobutylene-co-paramethylstyrene based elastomers (e.g., Elastomers 10-15). To achieve the compositions characterized in Table 11, Exxpro™ 3035 was mixed with varying amounts of Di-Cup® or Luperox® 101 in a 280 gram mixing bowl at about 100 °C. The temperature was then raised to 190 °C and the batch was further mixed for 5 minutes.

TABLE 11
Example Elastomer Compositions

| T = 190 °C | Exxpro ™ | Di- | Luperox ® | | Exxpro ™ | Di- | Luperox ® |
|---|---|---|---|---|---|---|---|
| Mix for 5 | 3035 | Cup ® | 101 | Total | 3035 | Cup ® | 101 |
| minutes | (phr) | (phr) | (phr) | phr | (g) | (g) | (g) |
| Elastomer 10 | 100.0 | 0.5 | 0 | 100.5 | 258.71 | 1.29 | 0 |
| Elastomer 11 | 100.0 | 1.0 | 0 | 101 | 257.43 | 2.57 | 0 |
| Elastomer 12 | 100.0 | 0 | 0.25 | 100.25 | 259.35 | 0 | 0.65 |
| Elastomer 13 | 100.0 | 0 | 0.5 | 100.50 | 258.71 | 0 | 1.29 |
| Elastomer 14 | 100.0 | 0 | 1.0 | 101.0 | 257.43 | 0 | 2.57 |
| Elastomer 15 | 100.0 | 0 | 2.0 | 102.0 | 254.90 | 0 | 5.10 |

Additionally, Table 12 presents the molecular weight and MWD data for example Elastomers 12-15 as determined using a light scattering detector. Further, Table 13 presents the molecular weight and MWD data for example Elastomers 12-15, as determined using a universal calibration with inline viscometer data.

TABLE 12
Light Scatter Detector

| | Mn | Mw | Mz | |
|---|---|---|---|---|
| | (kDa) | (kDa) | (kDa) | Mw/Mn |
| Elastomer 10 | 113.3 | 549.7 | 4717.7 | 4.9 |
| Elastomer 11 | 75.2 | 475.9 | 2648.3 | 6.3 |
| Elastomer 12 | 107.7 | 624.9 | 2837.1 | 5.8 |
| Elastomer 13 | 95.2 | 418.4 | 1675.6 | 4.4 |
| Elastomer 14 | 62.8 | 253.0 | 962.2 | 4.0 |
| Elastomer 15 | 25.1 | 194.3 | 2045.8 | 7.7 |

TABLE 13
Universal Calibration

| | Mn | Mw | Mz | |
|---|---|---|---|---|
| | (kDa) | (kDa) | (kDa) | Mw/Mn |
| Elastomer 10 | 161.6 | 445.8 | 1347.3 | 2.8 |
| Elastomer 11 | 107.4 | 353.5 | 1032.2 | 3.3 |
| Elastomer 12 | 156.4 | 470.3 | 1263.0 | 3.0 |
| Elastomer 13 | 110.4 | 338.1 | 935.6 | 3.1 |
| Elastomer 14 | 65.8 | 208.4 | 559.9 | 3.2 |
| Elastomer 15 | 36.6 | 133.8 | 493.3 | 3.7 |

Moreover, Table 14 includes the FTIR data of Elastomers 10-15. In particular, Table 14 depicts the mole percent of the brominated and non-brominated paramethylstyrene (“PMS”) component of the elastomers.

TABLE 14
FTIR Data

| | Br-PMS | PMS | Water | Stearic Acid |
|---|---|---|---|---|
| | Mol % | Mol % | Wt % | Wt % |
| Elastomer 10 | 0.367 | 2.057 | 0.1 | 0.17 |
| Elastomer 11 | 0.256 | 2.086 | 0.11 | 0.35 |
| Elastomer 12 | 0.451 | 2037 | 0.08 | 0.08 |
| Elastomer 13 | 0.416 | 2.028 | 0.11 | 0.18 |
| Elastomer 14 | 0.346 | 2.017 | 0.15 | 0.25 |
| Elastomer 15 | 0.292 | 2.03 | 0.17 | 0.18 |

As demonstrated by Elastomers 10-15, optimizing the amount of peroxide used to treat the isobutylene-co-paramethylstyrene based elastomer can affect the amount of brominated paramethylstyrene. For example, Elastomers 10-15 exhibit high amounts of brominated paramethylstyrene, which can promote further crosslinking in various industrial applications.

Table 15, presented below, depicts the Mooney viscosity of Exxpro™ 3035 and Elastomers 12-14, each of which comprised 5 wt % of paramethylstyrene.

TABLE 15

| | Mooney |
|---|---|
| Samples* | Viscosity** |
| Exxpro ™ 3035 | 46.6 |
| Elastomer 12 | 32.2 |
| Elastomer 13 | 31.9 |
| Elastomer 14 | 24.6 |

*Each sample comprising 5 wt % of paramethylstyrene
**ML, 1 + 8 at 125 °C

Further, Elastomers 12-14 were blended with Exxpro™ 3035, where Table 16 depicts the molecular weight and MWD data for the elastomers, as determined by the light scattering detector.

TABLE 16
Light Scattering Detector

| | Blending | Mn | Mw | Mz | |
|---|---|---|---|---|---|
| | Ratio* | (kDa) | (kDa) | (kDa) | Mw/Mn |
| Exxpro ™ 3035 + | 1:1 | 146 | 498.2 | 1506.8 | 3.41 |
| Elastomer 12 | | | | | |
| Exxpro ™ 3035 + | 1:1 | 124 | 411.7 | 992.8 | 3.32 |
| Elastomer 13 | | | | | |
| Exxpro ™ 3035 + | 1:1 | 94.9 | 380.2 | 927.1 | 4.01 |
| Elastomer 14 | | | | | |

*Blending ratio = Exxpro ® 3035 to example elastomer.

Advantageously, the peroxide treatment described herein can modify the MWD of halogenated (e.g., brominated) isobutylene-co-paramethylstyrene based elastomers while forming a substantially soluble non-gelatinous product (e.g., while avoiding gel formation). For example, the peroxide treatment conditions described herein can result in modified halogenated (e.g., brominated) isobutylene-co-paramethylstyrene elastomer compositions without substantial amounts of gel formation.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps. Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method for preparing an isobutylene-co-paramethylstyrene composition, the method comprising:
treating an isobutylene-co-paramethylstyrene based elastomer with a peroxide initiator at a temperature greater than or equal to 160 °C to chemically induce a thermal breaking along the copolymer backbone of the isobutylene-co-paramethylstyrene based elastomer, wherein the treating produces a modified isobutylene-co-paramethylstyrene based elastomer having a Mw/Mn ratio greater than 2.5.

2. The method of claim 1, wherein the treating comprises an amount of the peroxide initiator ranging from 0.2 to 4.5 weight percent, based on the isobutylene-co-paramethylstyrene based elastomer.

3. The method of claim 2, wherein the temperature ranges from 160 to 190 °C.

4. The method of claim 1, wherein the isobutylene-co-paramethylstyrene based elastomer comprises 80 to 99.5 mole percent of isobutylene and 0.5 to 20 mole percent of paramethylstyrene.

5. The method of claim 4, wherein the isobutylene-co-paramethylstyrene based elastomer comprises 5 mole percent of the paramethylstyrene.

6. The method of claim 4, wherein the isobutylene-co-paramethylstyrene based elastomer has an average molecular weight (Mw) ranging from, for example, about 200,000 to about 2,000,000 Daltons.

7. The method of claim 1, wherein the isobutylene-co-paramethylstyrene based elastomer has a Mw/Mn ratio less than 2.5.

8. The method of claim 7, wherein the isobutylene-co-paramethylstyrene based elastomer has a Mw/Mn ratio less than 2.0.

9. The method of claim 1, further comprising:
blending the modified isobutylene-co-paramethylstyrene based elastomer with an amount of the isobutylene-co-paramethylstyrene based elastomer to control a Mw/Mn ratio of the isobutylene-co-paramethylstyrene composition.

10. The method of claim 9, wherein the blending is performed with a blending ratio of the isobutylene-co-paramethylstyrene based elastomer to the modified isobutylene-co-paramethylstyrene based elastomer that ranges from 0.5:1.0 to 2.0:1.0.

11. The method of claim 10, wherein the blending ratio is 1:1.

12. The method of claim 9, wherein the Mw/Mn ratio of the isobutylene-co-paramethylstyrene composition is at least two times greater than the Mw/Mn ratio of the isobutylene-co-paramethylstyrene based elastomer.

13. The method of claim 12, wherein the Mw/Mn ratio of the isobutylene-co-paramethylstyrene composition ranges from 6.0 to 10.0.

14. The method of claim 1, wherein the isobutylene-co-paramethylstyrene based elastomer is halogenated prior to the treating with the peroxide initiator.

15. The method of claim 1, further comprising:
halogenating the modified isobutylene-co-paramethylstyrene based elastomer.

16. The method of claim 9, further comprising:
halogenating the modified isobutylene-co-paramethylstyrene based elastomer prior to the blending.

17. The method of claim 9, further comprising:
halogenating the modified isobutylene-co-paramethylstyrene based elastomer subsequent to the blending.

18. A method for preparing an isobutylene-co-paramethylstyrene based elastomer, the method comprising:
increasing a low molecular weight fraction of an isobutylene-co-paramethylstyrene based elastomer by mixing the isobutylene-co-paramethylstyrene based elastomer with a peroxide initiator at a temperature greater than or equal to 160 °C, wherein the mixing produces a modified isobutylene-co-paramethylstyrene based elastomer having a Mw/Mn ratio greater than 2.5.

19. The method of claim 18, wherein the isobutylene-co-paramethylstyrene based elastomer is a non-halogenated elastomer, a halogenated elastomer, a branched elastomer, or a combination thereof.

20. The method of claim 19, wherein the isobutylene-co-paramethylstyrene based elastomer comprises 80 to 99.5 mole percent of isobutylene and 0.5 to 20 mole percent of paramethylstyrene.

21. The method of claim 20, further comprising:
blending the modified isobutylene-co-paramethylstyrene based elastomer with an amount of the isobutylene-co-paramethylstyrene based elastomer to control a Mw/Mn ratio of the isobutylene-co-paramethylstyrene composition.

22. The method of claim 21, wherein the blending is performed with a blending ratio of the isobutylene-co-paramethylstyrene based elastomer to the modified isobutylene-co-paramethylstyrene based elastomer that ranges from 0.5:1.0 to 2.0:1.0.

23. An isobutylene-co-paramethylstyrene based elastomer comprising 80 to 99.5 mole percent of isobutylene and 0.5 to 20 mole percent of paramethylstyrene, having a substantially homogenous compositional distribution, and having a Mw/Mn ratio greater than 6.0.

24. The isobutylene-co-paramethylstyrene based elastomer of claim 23, wherein the paramethylstyrene is represented by the formula: 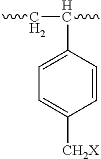
wherein X is hydrogen or a halogen.

25. The isobutylene-co-paramethylstyrene based elastomer of claim 24, wherein X is bromine.

26. A cured article comprising the isobutylene-co-paramethylstyrene based elastomer of claim 24, wherein the cured article is a tire innerliner, an innertube, a wire coating, a pharmaceutical rubber stopper, a hose, a film, an adhesive, or a sealant.
